(19) United States
(12) Patent Application Publication
(10) Pub. No.: US 2010/0159950 A1
(43) Pub. Date: Jun. 24, 2010

(54) RADIO COMMUNICATION BASE STATION DEVICE, RADIO COMMUNICATION TERMINAL DEVICE, AND GAP GENERATION METHOD

(75) Inventors: Hong Tat Toh, Singapore (SG); Takhisa Aoyama, Osaka (JP); Hidenori Matsuo, Osaka (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/665,188

(22) PCT Filed: Jun. 18, 2008
(86) PCT No.: PCT/JP2008/001570

§ 371 Date: Jan. 6, 2010

(30) Foreign Application Priority Data
Jun. 19, 2007 (JP) 2007 161956
Mar. 21, 2008 (JP) 2008 074330

(51) Int. Cl. H04W 64/00

(52) U.S. Cl. 455/456.1

(57) ABSTRACT

It is possible to provide a radio communication base station device, a radio communication terminal device, and a radio communication method which reduce a signaling load and perform flexible gap allocation. A target gap length generation unit (120) uses gap parameter configuration information acquired from a gap parameter generation unit (110) to subtract a gap offset from a maximum permissible gap length so as to calculate a minimum gap length. Moreover, when a new gap offset is reported from a network, a target gap length generation unit (120) re-calculates the minimum gap length according to the maximum permissible gap length which can be used.

### TECHNICAL FIELD

The present invention relates to a wireless communication base station apparatus, wireless communication terminal apparatus and gap generating method for performing gap allocation.

### BACKGROUND ART

In a cellular communication system represented by UMTS (Universal Mobile Telecommunication System), a terminal needs to perform inter-frequency measurement and inter-RAT measurement. The terminal needs to tune its receiver from the frequency of the source cell to another frequency or another RAT of neighboring cells, such that the terminal can receive a different carrier to perform inter-frequency measurement, or receive a signal from another cell of a different RAT to perform inter-RAT measurement.

In order to allow the terminal to perform inter-frequency measurement or inter-RAT measurement, idle periods in which the serving base station does not transmit data must be provided in the terminal. Note that synchronization needs to be established between the serving base station and the terminal.

In UMTS, compressed mode is provided to allow a terminal to perform inter-frequency measurement or inter-RAT measurement. In compressed mode, idle periods, also referred to as “gaps,” are provided, and set to the terminal by the serving base station such that inter-frequency measurement or inter-RAT measurement is performed during these gaps. Similarly, compressed mode may be executed only in downlink, or may be executed at the same time both in downlink and uplink.

Further, in UMTS, transmission slots are used as units of gaps provided for inter-frequency measurement and inter-RAT measurement. Compressed mode employs a gap pattern sequence formed by several periodical gaps.

Further, W-CDMA is employed in UMTS and, upon compressed mode, the spreading factor is decreased to decrease the number of transmission frames. Here, in a transmission frame in compressed mode, to maintain the same data rate as a transmission frame in non-compressed mode, it is necessary to increase transmission power for data transmission in non-gap time slots in the gap pattern sequence.

By the way, in the LTE (Long Term Evolution) communication system, compressed mode is not provided unlike UMTS. Further, instead of dedicated channels in UMTS, a shared channel is used. That is, the channel that transmits and receives data is shared between all users. With LTE, the shared channel is used, and therefore a scheduler entity needs to allocate radio resources to different users based on the request condition by each user.

This scheduler mechanism is used in a MAC layer and therefore radio resources allocated to the terminal are controlled by the MAC layer from the network. To support inter-frequency measurement or inter-RAT measurement in LTE, idle periods are allocated to the terminal, such that the terminal can re-tune the frequency of its receiver from the frequency of the source cell to another frequency or another RAT of neighboring cells and start monitoring that frequency. To support such measurements, downlink (DL)/uplink (UL) idle periods, also referred as “idle gap patterns,” are necessary to allow the terminal to monitor other neighboring cells.

Radio resources are not allocated to the terminal continuously, and therefore the terminal needs to reply on a scheduler to learn whether or not radio resources are allocated to that terminal. Accordingly, unlike UMTS, an idle gap pattern can be defined as an interval in which resource allocation is not performed. These idle gap patterns are allocated by the serving base station to the terminal as in UMTS. However, the scheduler has the function of allocating radio resources to the terminal and therefore the MAC layer controls the activation or deactivation of the idle gap patterns.

In an LTE communication system, gap allocation is adopted in inter-frequency measurement or inter-RAT measurement. With LTE, there are a greater number of inter-frequency carriers and additional RAT's, the terminal performs inter-frequency measurement or inter-RAT measurement more often than in UMTS. Therefore, the terminal supports idle gap patterns more often than in UMTS. In addition, the requirement of each gap length used to perform such measurements is different depending on (a) inter-frequency measurement and inter-RAT measurement and (b) purposes such as execution or re-execution of a procedure of cell search.

Non-Patent Document 1 discloses a flexible gap allocation technique in LTE. According to this technique, closed-loop control is used, so that the terminal can engage in prior estimation of the time required for measurement. With this approach, the terminal requests gaps by sending an uplink request signal (e.g. MAC control signaling) to the network. Further, based on scheduling of downlink data, the network allocates individual gap lengths based on a gap length T, to the terminals by means of MAC control signaling. Thus, the gap length of each gap depends on downlink data scheduling specified in the terminal by the network.

Non-Patent Document 1: “Measurement Gap Scheduling,” QUALCOMM Europe, Riga, Latvia, 3GPP TSG-RAN WG2 #56, R2-063103, 6-10 Nov. 2006

### DISCLOSURE OF INVENTION

### Problems to be Solved by the Invention

With the technique disclosed in Non-Patent Document 1, the network changes individual gap lengths based on scheduling of downlink data. However, if a great number of neighbouring cells are detected by a terminal, a longer measurement period is required. Accordingly, the terminal requires the increased number of gaps. In the LTE communication system, a greater number of carrier frequencies and other RAT's are available compared to UMTS, and therefore the terminal uses gaps more often to perform inter-frequency measurement or inter-RAT measurement with respect to detected neighboring cells. Accordingly, with LTE, there is a problem that signaling load increases due to a closed loop approach.

It is therefore an object of the present invention to provide a wireless communication base station apparatus, wireless communication terminal apparatus and gap generating method for reducing signaling load and performing flexible gap allocation.

### Means for Solving the Problem

The wireless communication terminal apparatus according to the present invention employs a configuration which includes: a receiving section that receives gap parameter configuration information; a target gap length generating section that generates a target gap length by subtracting a gap offset from a maximum allowable gap length using the gap parameter configuration information, and that generates a target gap length again when a new gap offset is acquired; and a measurement section that performs measurement based on the generated target gap length.

The wireless communication base station apparatus according to the present invention employs a configuration which includes: a minimum gap length calculating section that calculates a minimum gap length using a gap offset and a maximum allowable gap length allocated based on a measurement requirement of a wireless communication terminal apparatus; a gap offset generating section that generates the gap offset based on a threshold decision result of a predetermined threshold and a number of response signals transmitted from the wireless communication terminal apparatus; and a transmitting section that transmits the minimum gap length and the gap offset.

The gap generating method according to the present invention includes: receiving gap parameter configuration information; generating a target gap length by subtracting a gap offset from a maximum allowable gap length using the gap parameter configuration information; generating a target gap length again when a new gap offset is acquired; and generating a gap pattern based on the target gap length that is generated or generated again.

### ADVANTAGEOUS EFFECTS OF INVENTION

According to the present invention, it is possible to reduce signaling load and perform flexible gap allocation.

### BRIEF DESCRIPTION OF DRAWINGS

FIG. 1 is a block diagram showing a configuration of a terminal according to Embodiment 1 of the present invention;

FIG. 2 is a block diagram showing a configuration of a base station according to Embodiment 1 of the present invention;

FIG. 3 shows a signaling flow between the terminal shown in FIG. 1 and the base station shown in FIG. 2;

FIG. 4 shows that a gap length is changed in case where the number of radio quality reports exceeds a threshold;

FIG. 5 shows that the gap length is changed in case where the number of radio quality reports is less than a threshold;

FIG. 6 is a block diagram showing a configuration of the terminal according to Embodiment 2 of the present invention;

FIG. 7 illustrates a threshold controlling method used to detect a received response signal in the terminal shown in FIG. 6;

FIG. 8 is a block diagram showing a configuration of the base station according to Embodiment 3 of the present invention;

FIG. 9 is a block diagram showing a configuration of the base station according to Embodiment 4 of the present invention;

FIG. 10 shows a signaling flow between the terminal and the base station according to Embodiment 5 of the present invention;

FIG. 11 shows a procedure of processing a traffic load indicator in a terminal;

FIG. 12 is a block diagram showing a configuration of the terminal according to Embodiment 6 of the present invention;

FIG. 13 shows that the gap length is changed in case where a terminal is moving at low speed;

FIG. 14 shows the gap length is changed in case where a terminal is moving at high speed;

FIG. 15 is a table showing a list of measurement target frequencies;

FIG. 16A shows that a correlation peak is selected from a correlation calculation result in timing synchronization processing of a cell search;

FIG. 16B shows that a correlation peak is selected from a correlation calculation result in timing synchronization processing of a cell search;

FIG. 17 is a block diagram showing a configuration of the base station according to Embodiment 7 of the present invention; and

FIG. 18 shows a signaling flow between the terminal shown in FIG. 1 and the base station shown in FIG. 17.

### BEST MODE FOR CARRYING OUT THE INVENTION

Embodiments of the present invention will be explained in detail below with reference to the accompanying drawings. Here, in the embodiments, the components having the same functions will be assigned the same reference numerals and overlapping explanation thereof will be omitted.

### Embodiment 1

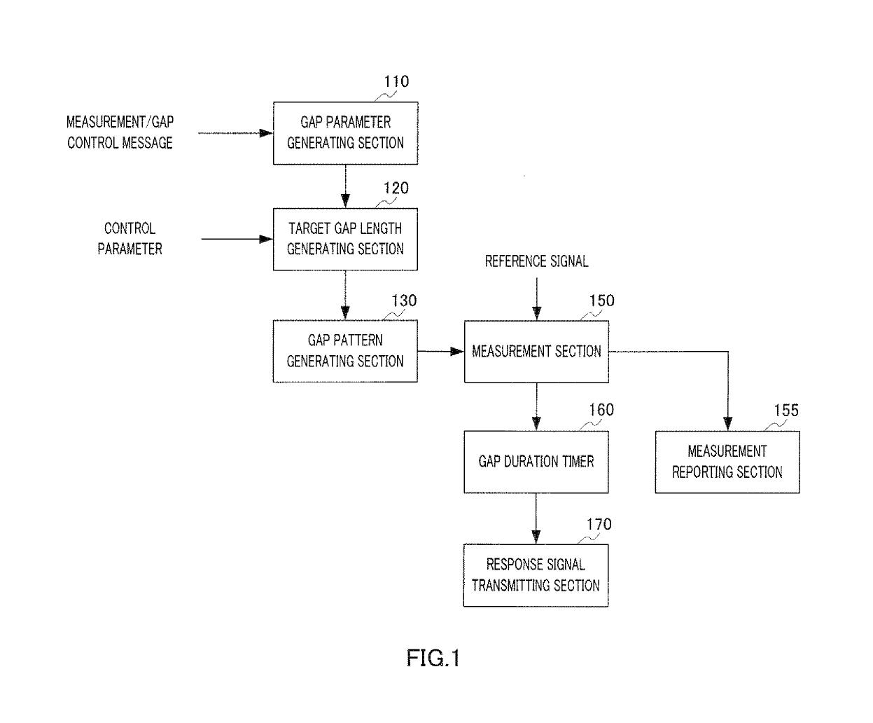

The configuration of a wireless communication terminal apparatus (hereinafter simply “terminal”) according to Embodiment 1 of the present invention will be explained using FIG. 1. The terminal receives measurement configuration information and gap pattern configuration information from dedicated control signaling, that is, receives a measurement/gap control message from a network (for example, a wireless communication base station apparatus). Here, “measurement” refers to measurement performed by a terminal to learn which cell provides good received quality to the terminal. This measurement enables the terminal to learn which cell provides good received quality, and enables the network to select a cell that provides adequate received quality to a terminal by reporting a measurement result to the network.

Gap parameter generating section 110 of a receiving means receives a measurement/gap control message transmitted from the network, and stores gap parameter configuration information included in the measurement/gap control message and the setting of measurement performed during gaps. Here, information about gap control includes the gap length which is the length of one gap used to generate gaps, inter-gap distance between two gaps, and gap offset (described later). Further, information about measurement includes information about the measurement method or the method of reporting measurement results that has been reported by a measurement control message with UMTS. Further, hereinafter, the gap length is defined as the maximum allowable gap length.

Target gap length generating section 120 acquires gap parameter configuration information stored in gap parameter generating section 110 and the setting of measurement performed during gaps, subtracts a gap offset from the maximum allowable gap length using the acquired gap parameter configuration information and calculates each target gap length, also referred to as “minimum gap length.”

Further, when receiving control parameters from the network, target gap length generating section 120 performs the two procedures of (1) activating/deactivating gaps and (2) changing a gap offset. As for procedure 1, the available configuration gap pattern is activated or deactivated using control parameters based on decision of the network. That is, a specific example of information includes a flag indicating activation/deactivation of gaps formed by gap parameter generating section 110 and information such as an index indicating gaps generated in gap parameter generating section 110. For procedure 2, the network reports a new gap offset to a terminal. Therefore, a specific example of information includes a new gap offset value. By this means, target gap length generating section 120 recalculates a minimum gap length based on the received gap offset and an available maximum allowable gap length, and outputs the measurement setting and parameters such as the minimum gap length, maximum allowable gap length and the inter-gap distance.

Gap pattern generating section 130 sets parameters such as the minimum gap length, maximum allowable gap length and inter-gap distance outputted from target gap length generating section 120, to measurement section 150 of a lower layer. Further, gap pattern generating section 130 sets the gap pattern sequence to measurement section 150 based on the gap parameters, and further determines the measurement setting through gap parameter generating section 110 and target gap length generating section 120.

After finishing the procedure of setting the gap pattern based on the content set by gap pattern generating section 130, measurement section 150 starts measurement at gap intervals. Further, measurement section 150 requires a physical layer reference signal to perform measurement.

Furthermore, before performing inter-frequency measurement and inter-RAT measurement, it is necessary to detect a cell. Therefore, measurement section 150 performs a procedure of cell search and procedure of measurement, and learns that each measurement task has been finished or measurement processing has been finished. If measurement processing has been finished, a measurement result is acquired. If measurement section 150 finishes a measurement task, it is reported to gap duration timer 160 that the measurement task has been finished. On the other hand, if measurement section 150 finishes the measurement processing and acquires a measurement result, measurement section 150 outputs the measurement result to measurement reporting section 155.

Measurement reporting section 155 creates a measurement report based on the measurement result outputted from measurement section 150, and sends the created measurement report to the network through dedicated control signaling.

Gap duration timer 160 is triggered by the report from measurement section 150 to measure the gap duration, and decides whether or not a gap duration corresponding to the minimum gap length has passed. Based on this decision result, gap duration timer 160 commands response signal transmitting section 170 to send a response signal immediately before the maximum allowable gap length passes or immediately after the maximum allowable gap length passes.

Response signal transmitting section 170 transmits the response signal to the network according to the command from gap duration timer 160.

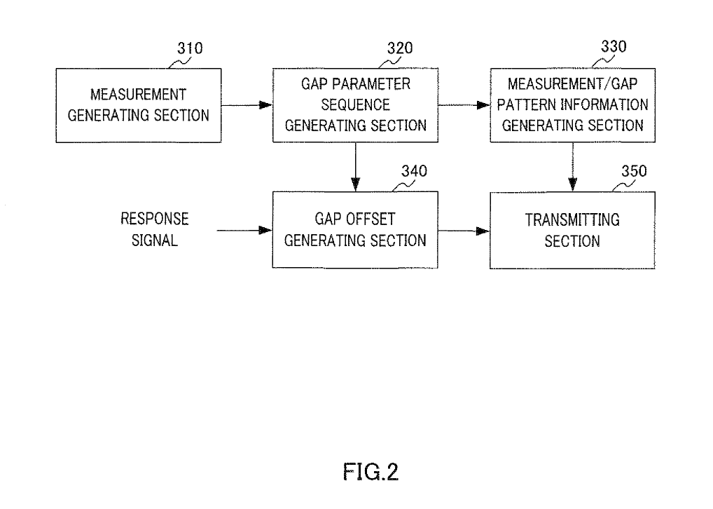

Next, a configuration of a wireless communication base station apparatus (hereinafter simply “base station”) according to Embodiment 1 of the present invention will be explained using FIG. 2. Note that the base station will be explained here as an example of a network.

After determining a gap acquisition requirement for the terminal to perform measurement, measurement generating section 310 initializes the parameters for the measurement configuration in inter-frequency measurement or inter-RAT measurement, and outputs the parameters as the measurement requirement for the terminal, to gap parameter sequence generating section 320.

Based on the measurement requirement for the terminal outputted from measurement generating section 310, gap parameter sequence generating section 320 of a minimum gap length generating means allocates gap parameters such as the maximum allowable gap length, inter-gap distance and gap offset, to each terminal. Then, gap parameter sequence generating section 320 calculates each gap length, also referred to as “minimum gap length,” based on the maximum allowable gap length and gap offset parameters. These gap parameters and the parameters for the measurement configuration are outputted to measurement/gap pattern information generating section 330.

Measurement/gap pattern information generating section 330 generates measurement/gap control information based on the parameters for the measurement configuration, and the gap parameters outputted from gap parameter sequence generating section 320, and outputs the generated measurement/gap control information to transmitting section 350.

Gap offset generating section 340 stores gap parameters such as the maximum allowable gap length, minimum gap length and gap offset outputted from gap parameter sequence generating section 320. When receiving as input the response signal, gap offset generating section 340 decides whether or not the number of response signals exceeds a predetermined threshold, based on the allocated gap length. If the number of response signals exceeds or goes below the threshold in the allocated gap length, gap offset generating section 340 changes the gap offset based on the response signal and recalculates the minimum gap length based on the changed gap offset. The changed gap offset parameter is outputted to transmitting section 350.

Transmitting section 350 transmits the measurement/gap control information outputted from measurement/gap pattern information generating section 330, and the gap offset parameter outputted from gap offset generating section 340, to the terminal.

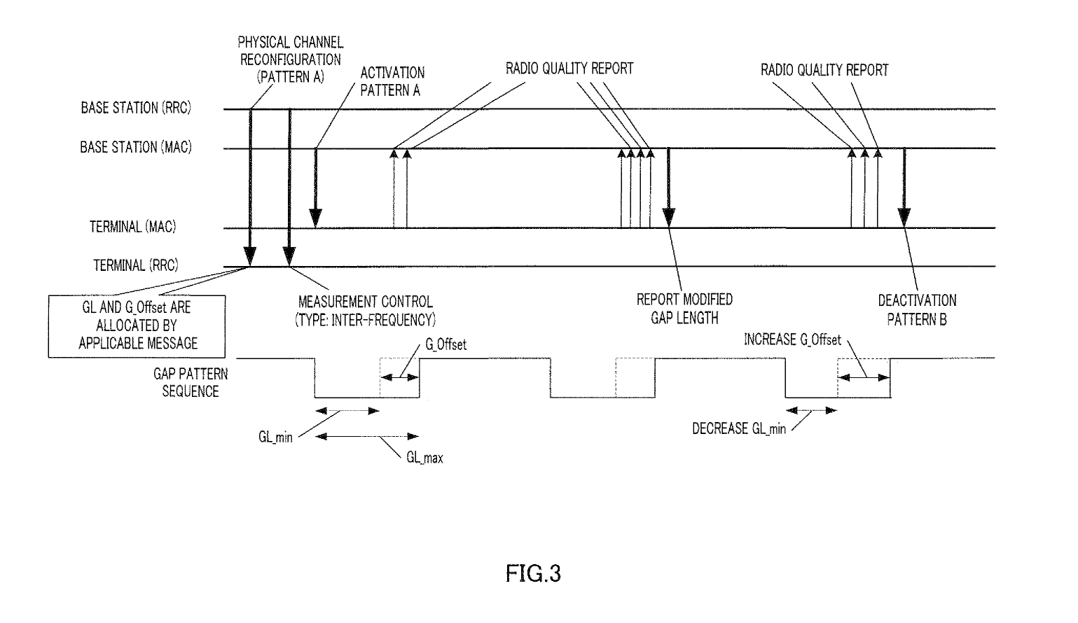

FIG. 3 shows a signaling flow between the terminal shown in FIG. 1 and the base station shown in FIG. 2. The base station signals gap pattern sequence setting information and measurement type information to the terminal. This signaling is the measurement/gap control message shown in FIG. 1, and is processed by gap parameter generating section 110. Further, FIG. 3 discloses a setting of measurement by measurement control, that is, discloses specifying how measurement is performed, and therefore a gap generating method will be mainly explained here.

The setting of a gap pattern sequence includes parameters such as the gap length “GL,” inter-gap distance, and gap offset “G_Offset.” Gap parameter setting information is stored in gap parameter generating section 110. This is reported according to the physical channel reconfiguration (pattern A) disclosed in FIG. 3.

The parameters of the gap length and inter-gap distance serve as sufficient information for a terminal to create a gap pattern sequence. The object of providing the gap offset parameter is to make the terminal to perform calculation and perform different measurement using a different target gap length, also referred to as “minimum gap length.” Target gap length generating section 120 calculates the minimum gap length “GL_min” based on the gap length and gap offset. The minimum gap length refers to a period in which a radio quality report (i.e. CQI report) cannot be transmitted although measurement can be performed.

In target gap length generating section 120, there are the following input parameters from two sequences for determining a gap pattern. That is, these input parameters include (1) the gap length and gap offset outputted from gap parameter generating section 110, and (2) the modified gap offset parameter included in the control parameters. These parameters from the two sequences are adopted to calculate “GL_min.” Here, (2) control parameters correspond to the modified gap length shown in FIG. 3. Here, the gap offset refers to a period in which measurement can be performed and in which a radio quality report (i.e. CQI report) may be transmitted.

If target gap length generating section 120 uses the parameters outputted from gap parameter generating section 110, the gap length parameter is acquired by subtracting the gap offset parameter from the gap length outputted from gap parameter generating section 110 and the resulting gap length has the same value as the “GL_min” value. This is the gap generating operation shown in FIG. 3 before the modified gap length is reported. Further, if target gap length generating section 120 uses the control parameters, the gap length parameter becomes the value subtracting the modified gap offset parameter of the control parameters, from the gap length parameter outputted from gap parameter generating section 110, and the gap offset parameter acquired from the control parameters as a calculation result has the same value as newly acquired “GL_min” value. This is the gap generating operation shown in FIG. 3 after the modified gap length is reported.

The length of new “GL_min” depends on the modified gap offset parameter of the control parameters. If the modified gap offset parameter increases, new “GL_min” decreases. By contrast with this, if the modified gap offset parameter decreases, new “GL_min” increases. Accordingly, the available gap parameters including “GL_min” are outputted to gap pattern generating section 130, and are used in processing for a gap pattern sequence configuration and so on.

For example, units of gap parameters depend on the number of TTI's (Time Transmission Intervals in LTE assuming that 1 TTI=1 ms (millisecond)). If the interval of a radio quality report is 5 milliseconds, that is, 5 TTI's, the setting is possible where gap length=30 TTI's and gap offset=10 TTI's. In this case, GL_min is calculated as follows. GL_min=gap length−gap offset=30−10=20 TTI's

Further, if an interval of a radio quality report is 1 millisecond, that is, 1 TTI, with the setting of gap length=10 TTI's and gap offset=3 TTI's, GL_min can be calculated as follows. GL_min=gap length−gap offset=10−3=7 TTI's

Gap pattern generating section 130 sets the gap pattern sequence for the lower layer, so that measurement is prepared based on the minimum gap length “GL_min,” the maximum allowable gap length “GL_max” and the gap offset “G_Offset,” without activating gaps. Here, the maximum allowable gap length refers to the period in which measurement can be performed. In other words, the maximum allowable gap length is the maximum gap length in which the measurement operation is allowed,

The control of gap activation or deactivation is performed based on signals from the base station to the terminal. This signal is processed in target gap length generating section 120. This is activation pattern A shown in FIG. 3. By this means, gaps starts being generated using the gap parameter setting set in the physical channel reconfiguration. For example, it may be interpreted that signals are sent by means of MAC signaling in the same way control parameters are sent.

After gaps are activated and the procedure of measurement in the allocated gap length is finished, response signal transmitting section 170 of the terminal transmits a response signal to the base station such as a radio quality report, a resource request or other messages. This operation is performed in the MAC of the terminal.

Based on the response signal from the terminal, the base station decides whether or not the next gap allocation for the “G_Offset” value must be changed. “G_Offset” is changed in gap offset generating section 340. A response signal such as a radio quality report is received by gap offset generating section 340. The number of response signals received in G_Offset is used to perform a procedure of checking in gap offset generating section 340. The threshold defined for the allocated gap offset length is adopted in gap offset generating section 340 to decide whether the number of response signals received is greater or smaller than the threshold. If the number of response signals received in the gap offset “G_Offset” exceeds the threshold, gap offset generating section 340 increases the current gap offset length “G_Offset.” If the number of response signals received in the gap offset “G_Offset” goes below the threshold, gap offset generating section 340 decreases the current gap offset length “G_Offset” by network processing.

The changed “G_Offset” value is signaled from transmitting section 350 to the terminal, and is received by the terminal that is processing control parameters (that is in operation). These operations are performed in the MAC of the base station.

Further, although, with the above example, the number of response signals received in G_Offset is used to determine G_Offset, it is possible to determine G_Offset based on the position of the first response signal in G_Offset.

Based on the changed “G_Offset,” the terminal recalculates and resets the gap allocation. These recalculation and resetting are performed in target gap length generating section 120 and gap pattern generating section 130. These operations are performed in the MAC of the terminal.

The above approach is one method showing the signaling operation of the present invention. Other signaling may involve only one of RRC (Radio Resource Control) and MAC (Media Access Control) between the network and the terminal, or may use different combinations.

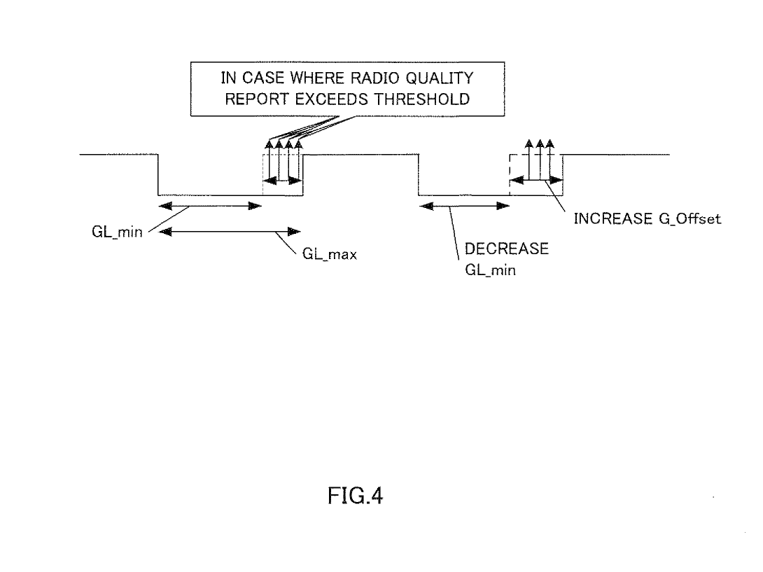

FIG. 4 shows that the gap length is changed in case where the number of radio quality reports exceeds a threshold. For each individual gap allocation, response signal transmitting section 170 of the terminal resumes reporting current radio quality after measurement is finished. In case where the terminal finishes the procedure of measurement early, the number of radio quality reports becomes more often.

A response signal such as a radio quality report is received by gap offset generating section 340 of the base station. The number of response signals received is used in gap offset generating section 340 to perform the procedure of checking.

The threshold is applied to the allocated gap offset length “G_Offset” in gap offset generating section 340. If the number of received radio quality reports exceeds the threshold in the gap offset length “G_Offset,” gap offset generating section 340 decides that the current target gap length, also referred to as the “minimum gap length,” for cell measurement is sufficient for the terminal to perform measurement.

Gap offset generating section 340 increases the length of the gap offset “G_Offset” for the next gap allocation, and signals the changed gap offset value to the terminal from transmitting section 350.

Target gap length generating section 120 of the terminal recalculates the minimum gap length based on the modified “G_Offset” value of control parameters. If the modified “G_Offset” value increases, the “GL_min” value decreases. Accordingly, gap pattern generating section 130 in operation resets the next gap allocation based on decreased “GL_min.”

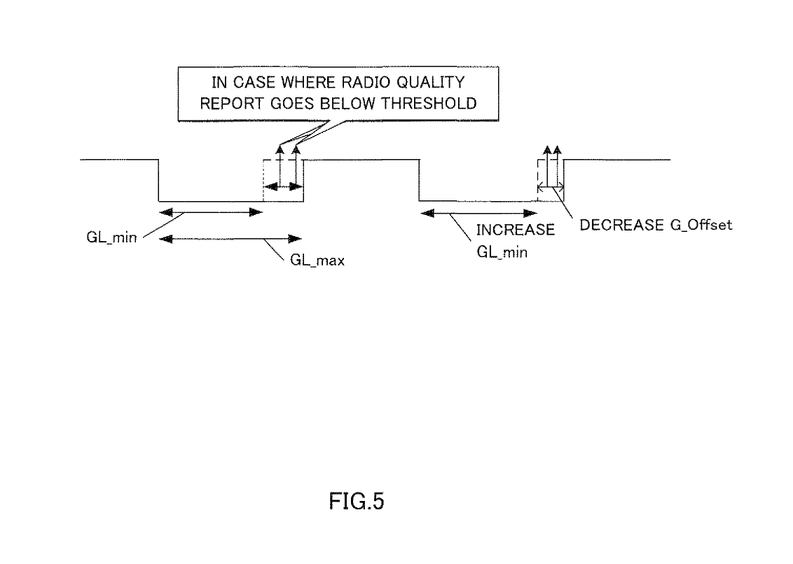

FIG. 5 shows that the gap length is changed in case where the number of radio quality reports goes below the threshold. For each gap allocation, response signal transmitting section 170 of the terminal resumes reporting the current radio quality after cell measurement is finished. The terminal finishes the procedure of measurement later, and therefore the number of radio quality reports is less often.

A response signal such as a radio quality report is received by gap offset generating section 340 of the base station. The number of response signals received is used by gap offset generating section 340 to perform the procedure of checking. The threshold is applied to the allocated gap offset length “G_Offset” in gap offset generating section 340.

If the number of radio quality reports received goes below the threshold in the gap offset length “G_Offset,” the base station decides that the minimum gap length for measurement is not sufficient for the terminal to perform measurement. Gap offset generating section 340 reduces the length of the gap offset “G_Offset” for the next gap allocation, and signals the changed gap offset value to the terminal from transmitting section 350.

Target gap length generating section 120 of the terminal recalculates the minimum gap length based on the modified “G_Offset” value of control parameters. If the modified “G_Offset” value decreases, the “GL_min” value increases. Accordingly, the terminal in operation resets the next gap allocation based on decreased “GL_min.”

The network decides whether or not current “G_Offset” has been modified, and therefore the above method is based on the number of response signals such as radio quality reports. If response signals are lost in this method, the setting of the number of response signals in “G_Offset” allocated in the terminal becomes different from the number of response signals set in the base station.

A response signal such as a radio quality report generally refers to a periodical report, and its interval is adjustable. Therefore, to solve this problem, measurement/gap pattern information generating section 330 may configure the intervals between received signals based on the allocated “G_Offset” length.

In this case, the base station recognizes that there is a possibility that a maximum allowable response signal has been received in the “G_Offset” length. Consequently, if a response signal between two successfully received response signals is lost, the base station can detect that the response signal has been lost. The base station increases the number of response signals taking into account how many response signals there are that are not successfully received between the two consecutive response signals. Accordingly, if response signals are lost, these lost signals are covered by gap offset generating section 340.

Next, the method of deciding whether or not a gap offset has been modified using the threshold will be explained except for the above method. To be more specific, the method of reporting from the terminal to the base station that whether or not the gap offset length needs to be modified for the next gap allocation, will be explained.

After measurement is finished, response signal transmitting section 170 of the terminal transmits a response signal to the base station. When transmitting this response signal, response signal transmitting section 170 decides two scenarios. That is, response signal transmitting section 170 decides whether or not the response signal is transmitted (1) long before a predetermined gap length (i.e. minimum gap length) passes or (2) at a time a gap offset ends before the maximum allowable gap length passes.

In scenario (1), the terminal learns whether the current desired gap length is adequate for measurement processing or is more than necessary. In case where the desired gap length is more than necessary, the terminal reports that “G_Offset” must be increased, to the base station through a dedicated control channel.

In scenario (2), the terminal learns that the current desired gap length is not sufficient for measurement processing. The terminal reports that “G_Offset” must be decreased, to the base station through a dedicated control channel.

Based on these scenarios, transmitting section 350 can provide a “G_Offset” status parameter (that is, increase or decrease of “G_Offset”) in dedicated control signaling such as a radio quality report. The “G_Offset” status parameter may represent an increase or decrease of the gap offset length on a per unit time basis. The unit time includes, for example, the radio quality report interval and TTI configured by a network.

For example, the unit of a gap parameter is represented by the number of TTI's and, in case where the radio quality report interval is 5 milliseconds, that is, 5 TTI's, the following equations hold.

Gap offset=10 TTI' “G_Offset” status=increase (i.e. +5 TTI's)

Modified gap offset=gap offset+“G_Offset” status=10+5=15 TTI's Gap offset=10 TTI's, “G_Offset” status=decrease (i.e. −5 TTI's)

Modified gap offset=gap offset+“G_Offset” status=10−5=5 TTI's

If a response signal is received and the “G_Offset” status parameter is included in the response signal, gap offset generating section 340 modifies the “G_Offset” length for the next gap allocation, based on the “G_Offset” status parameter. By contrast with this, if the “G_Offset” status parameter is not included in the response signal, gap offset generating section 340 does not modify the “G_Offset” length for the next gap allocation. Transmitting section 350 transmits the modified gap offset length to the terminal.

### Embodiment 2

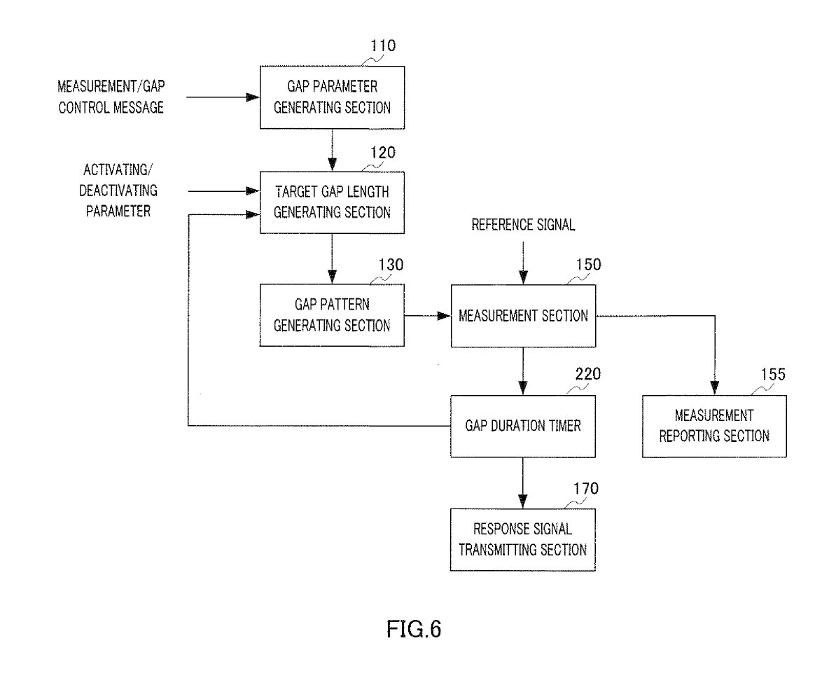

The configuration of the terminal according to Embodiment 2 of the present invention will be explained using FIG. 6. FIG. 6 differs from FIG. 1 in that target gap length generating section 120 does not receive as input the modified value of the gap offset and gap duration timer 160 is changed to gap duration timer 220.

Gap duration timer 220 is triggered by a report from measurement section 150 to measure the gap duration and decide whether or not the gap duration corresponding to the minimum gap length has passed. If the gap duration corresponding to the minimum gap length has not passed or if the time corresponding to the minimum gap length has passed before the measurement processing is finished and the amount of output signals from response signal transmitting section 170 exceeds or goes below a predetermined threshold, gap duration timer 220 outputs parameters such as the changed gap offset value, to target gap length generating section 120.

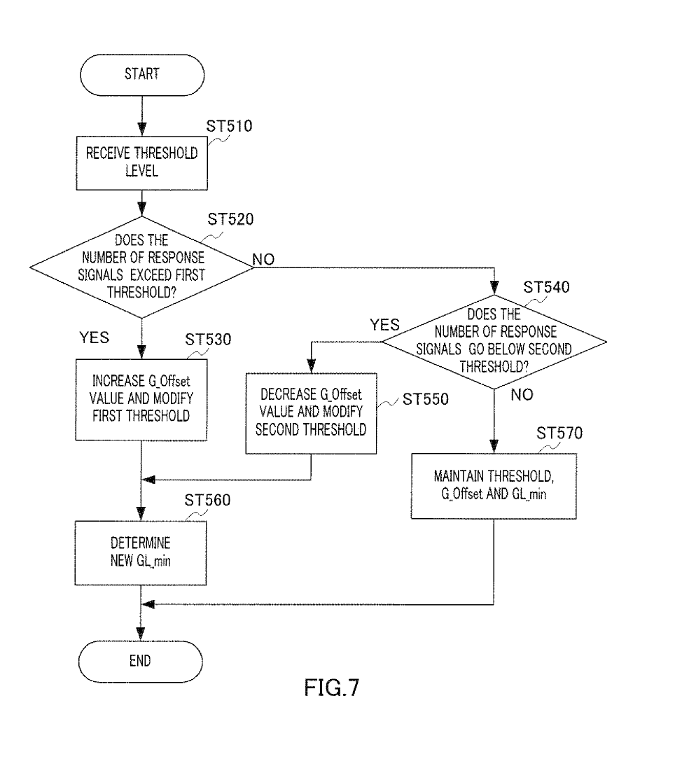

FIG. 7 illustrates a threshold controlling method used to detect a received response signal in the terminal shown in FIG. 6. Here, the gap length (i.e. minimum gap length referred to as “G_min”) is modified, and the gap offset length (i.e. “G_Offset”) is modified by detecting the threshold.

If, in step (hereinafter abbreviated as “ST”) 510, the first threshold and second threshold that relate to the current gap offset length and that are defined in advance are received, the procedure of checking is performed in ST 520. That is, the terminal decides whether or not the number of response signals received exceeds the first threshold. If the number of response signals received exceeds the first threshold (Yes), the step proceeds to ST 530 and, if the number of response signals received does not exceed the first threshold (No), the step proceeds to ST 540.

In ST 530, the G_Offset value is increased and the first threshold is modified based on the increased G_Offset value.

In ST 540, whether or not the number of response signals received goes below a second threshold level is decided. If the number of response signals received goes below the second threshold (Yes), the step proceeds to ST 550, and, if the number of response signals received does not go below the second threshold, the step proceeds to ST 570 (No).

In ST 550, the G_Offset value is decreased and the second threshold is modified based on the decreased G_Offset value.

In ST 560, new GL_min is determined based on the modified G_Offset value. Further, in ST 570, the current threshold level, G_Offset and GL_min are maintained.

Further, if a radio quality report that is transmitted exceeds or goes below a certain threshold, the terminal automatically changes the gap offset length in gap duration timer 220.

Further, the updated gap offset (i.e. autonomous gap offset) and the threshold modified based on the updated gap offset are transmitted from the terminal to the base station. The updated gap offset and updated threshold information are signaled through dedicated control signaling. Such signaling includes a radio quality report.

Furhter, threshold information in ST 510 is received by target gap length generating section 120. Accordingly, target gap length generating section 120 performs the procedure of checking in ST 520 and ST 540, modifies the “G_Offset” value in ST 530 and ST 550, and calculates new GL_min and maintains the current threshold level, G_Offset value and FL min value in ST 560.

Further, the operation of the base station according to the present embodiment is shown in FIG. 2 similar to Embodiment 1. Note that there are the following differences. That is, when the base station receives a response signal, gap offset generating section 340 checks the received response signal and a predetermined threshold level, and, if the response signal satisfies the threshold level, gap offset generating section 340 determines the changed gap offset and updates the minimum gap length parameter. Thanks to the operation by the base station and automatic updating by the terminal, gap offset generating section 340 of the base station does not need to transmit the changed gap offset parameter to the terminal. The base station only stores the gap offset updated in gap offset generating section 340 and the updated minimum gap length parameter.

### Embodiment 3

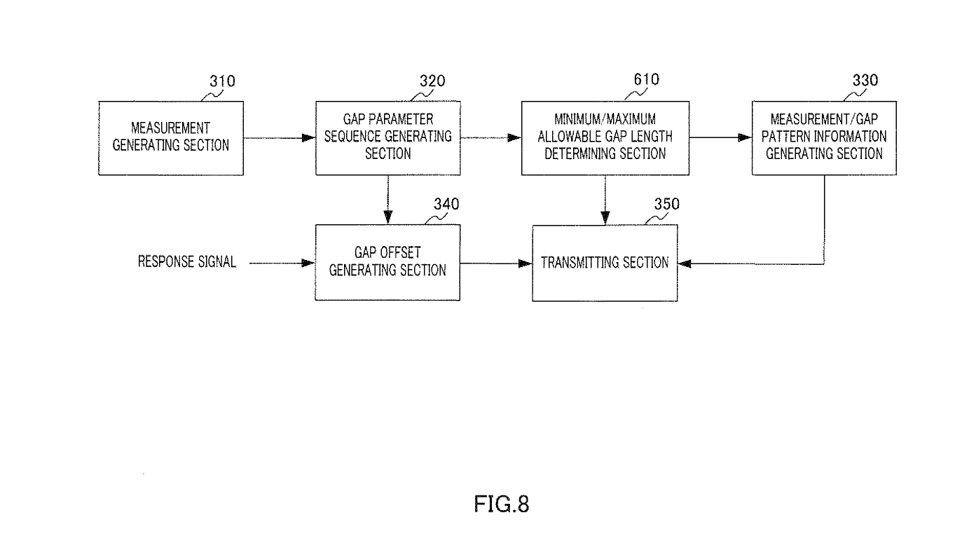

The configuration of the base station according to Embodiment 3 of the present invention will be explained using FIG. 8. Note that FIG. 8 differs from FIG. 2 in adding minimum/maximum allowable gap length determining section 610.

Minimum/maximum allowable gap length determining section 610 executes two scenarios of (1) inter-frequency measurement and inter-RAT measurement and (2) a cell search and measurement task, using the measurement setting and maximum allowable gap length outputted from gap parameter sequence generating section 320, and gap parameters such as the minimum gap length, gap offset and inter-gap distance.

In scenario (1), the base station allocates inter-frequency measurement and inter-RAT measurement setting information to the terminal. Minimum/maximum allowable gap length determining section 610 allocates gaps that are suitable to the terminal and that are required for inter-RAT measurement, to the maximum allowable gap length, and allocates gaps required for inter-frequency measurement, to the minimum gap length.

This is because inter-RAT measurement generally takes a long time compared to inter-frequency measurement. Consequently, by setting one gap pattern, it is possible to support both inter-frequency measurement and inter-RAT measurement.

By contrast with this, in scenario (2), the base station allocates one measurement setting information (e.g. inter-frequency measurement or inter-RAT measurement) to the terminal. In this case, minimum/maximum allowable gap length determining section 610 allocates gaps required for the procedure of cell search, to the maximum allowable gap length, and allocates gaps required for the procedure of measurement, to the minimum gap length.

This is because, even if the procedure of cell search requires longer gaps than the procedure of measurement, both procedures are operated using one gap pattern. If the procedure of cell search is finished in shorter gaps than the procedure of measurement, gaps for the procedure of cell search become the minimum gap length. If the method of using minimum and maximum allowable gap lengths (i.e. measurement setting information) is allocated, minimum/maximum allowable gap length determining section 610 outputs the related gap control/measurement setting information to measurement/gap pattern information generating section 330.

When receiving the gap control/measurement setting information, the terminal decides the purpose of use of the minimum and maximum allowable gap lengths based on the availability of measurement setting information. If one type of measurement configuration information (e.g. inter-frequency measurement or inter-RAT measurement) is available to the terminal, the terminal sets the lower layer such that the cell search task employs the maximum allowable gap length and the measurement task employs the minimum gap length. Further, if both inter-frequency measurement and inter-RAT measurement are available to the terminal, the terminal sets the lower layer such that inter-RAT measurement employs the maximum gap length and inter-frequency measurement employs the minimum gap length.

According to this setting, one gap pattern can support a plurality of operations that require different gap lengths. That is, with the maximum allowable gap length, although long gaps support required operations and, if processing is finished earlier in shorter gaps, communication can be started earlier, so that it is possible to prevent deterioration of communication speed.

### Embodiment 4

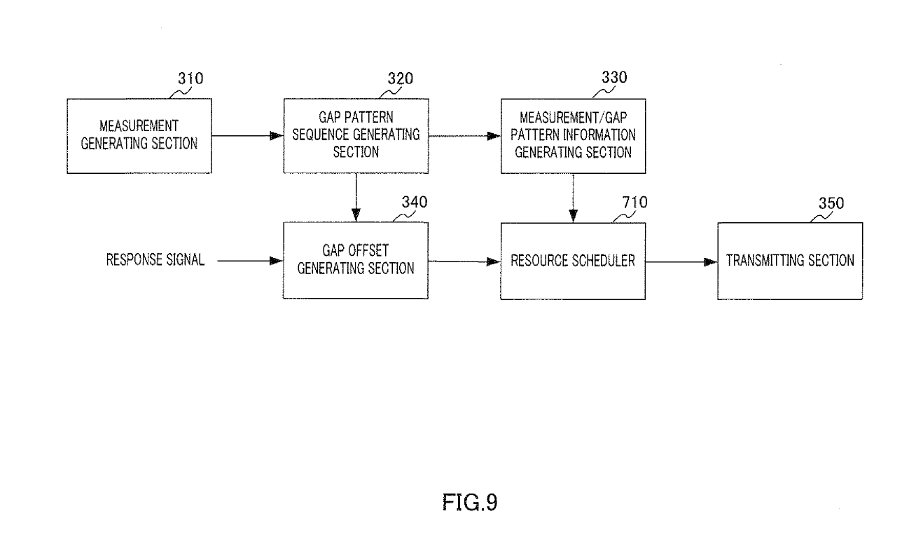

The configuration of the base station according to Embodiment 4 of the present invention will be explained using FIG. 9. FIG. 9 differs from FIG. 2 in adding resource scheduler 710.

When measurement/gap pattern information generating section 330 outputs information about measurement and gap control, resource scheduler 710 schedules radio resources, also referred to as “guard interval resource information,” having the length indicated by gap offset information. Here, guard interval resources refer to resources allocated to the terminal in a fixed manner, and allocated to another terminal while the terminal use gaps because the resources are not used by the terminal. That is, the guard interval resources refer to resources in which allocated resources and gaps overlap. Further, with the present invention, the period in which the terminal never uses these guard interval resources becomes the minimum gap length in the maximum allowable gap lengths.

The guard interval resources are changed when G_Offset of the terminal is changed. Therefore, the changed gap offset parameter needs to be used and, if gap offset generating section 340 outputs the changed parameters to resource scheduler 710, resource scheduler 710 reschedules guard interval resource information for the changed gap offset information in case where guard interval resources are allocated in a fixed manner to a specific terminal for a certain period. Guard interval resource information is signaled to the terminal through transmitting section 350.

### Embodiment 5

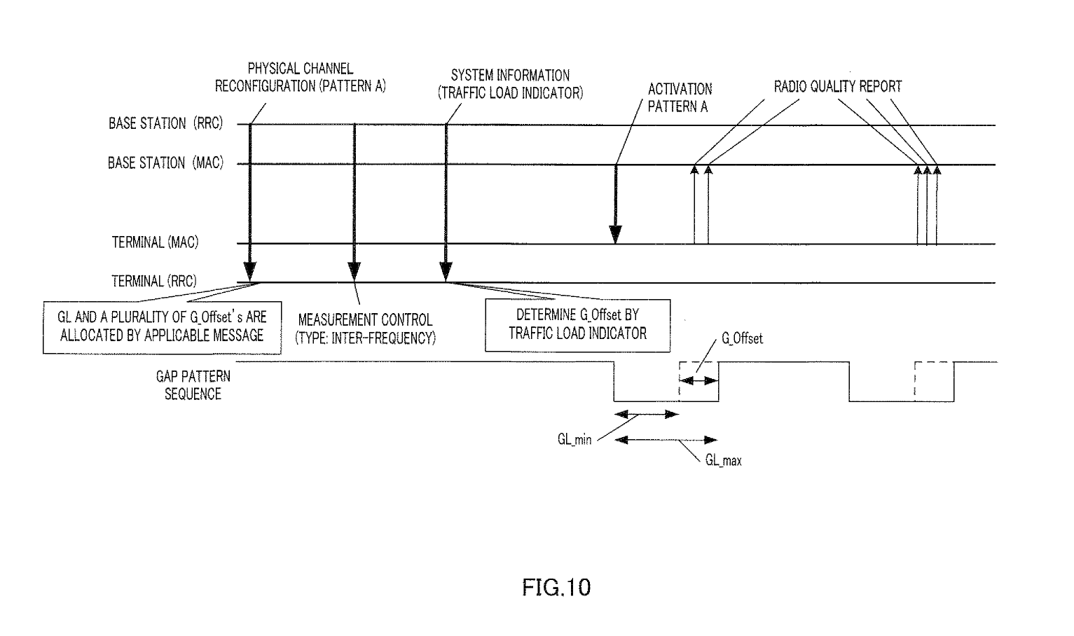

FIG. 10 shows a signaling flow between the terminal and the base station according to Embodiment 5 of the present invention. Here, a case will be studied where “G_Offset” is changed by the traffic in the serving cell. First, assume that traffic load information is reported from the serving base station to the terminal by broadcast information or dedicated signaling. At this time, the base station allocates a small “G_Offset” value to the terminal when traffic load is high, and allocates to the terminal a large “G_Offset” value when traffic load is low. Consequently, it is possible to increase guard interval resources when high traffic load is applied.

FIG. 10 shows an example where the serving base station provides a traffic load indicator in system information and signals system information to the terminal by broadcast transmission. The traffic load information is received and stored in gap parameter generating section 110 of the terminal.

Similarly, several “G_Offset” values are signaled to the terminal through dedicated control signaling. This signaling is received by gap parameter generating section 110 of the terminal.

Among these “G_Offset” values, target gap length generating section 120 of the terminal determines a suitable “G_Offset” value based on the traffic load indicator, and gap pattern generating section 130 configures the gap pattern sequence.

When the traffic load indicator changes, target gap length generating section 120 of the terminal automatically changes the “G_Offset” value.

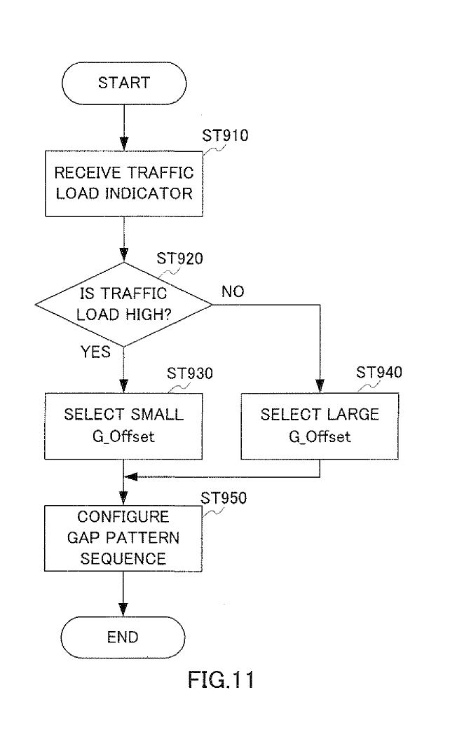

FIG. 11 shows the procedure of processing the traffic load indicator in the terminal. To be more specific, FIG. 11 shows a method of determining, in a terminal, a suitable gap offset “G_Offset” value based on the traffic load indicator of the serving cell.

In ST 910, target gap generating section 120 of the terminal receives the traffic load indicator, and, in ST 920, performs a procedure of checking to select a suitable gap offset value, also referred to as “G_Offset.” Further, the terminal decides the traffic load of the serving cell based on the traffic load indicator supplied by the base station. If it is decided that the traffic load is high (Yes), the step proceeds to ST 930, and, if it is decided that the traffic load is not high (No), the step proceeds to ST 940.

In ST 930, the terminal selects a small “G_Offset” value, and, in ST 940, the terminal selects a large “G_Offset” value.

Further, selection of the “G_Offset” value in ST 920, ST 930 and ST 940 is performed in target gap length generating section 120.

Accordingly, the “G_Offset” value selected by the terminal is used to configure the gap pattern sequence to perform measurement by gap pattern generating section 130 in ST 950.

### Embodiment 6

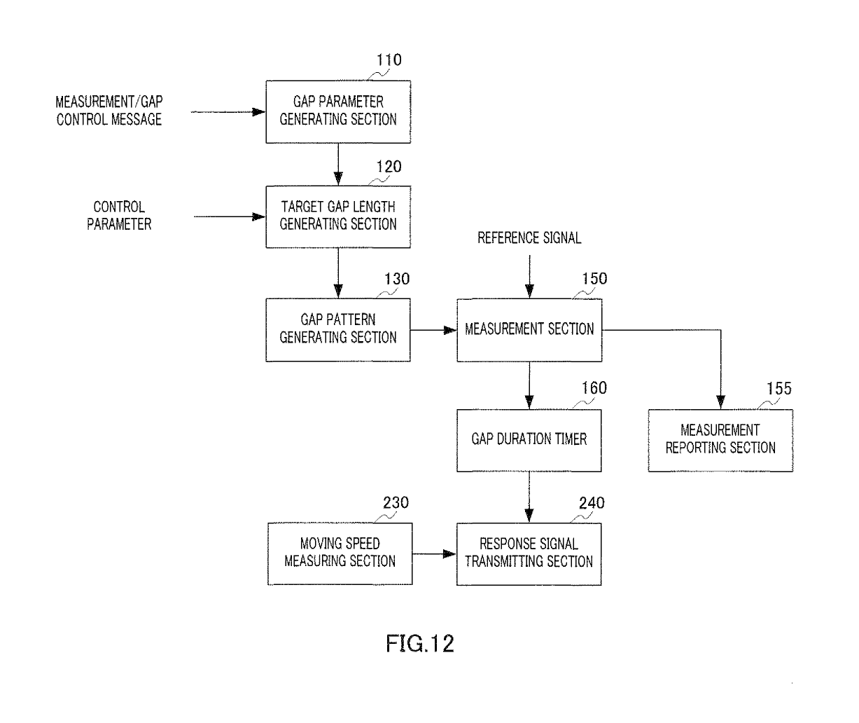

The configuration of the terminal according to Embodiment 6 of the present invention will be explained using FIG. 12. FIG. 12 differs from FIG. 1 in adding moving speed measuring section 230 and changing response signal transmitting section 170 to response signal transmitting section 240.

Moving speed measuring section 230 measures the moving speed of the terminal, and outputs the result to response signal transmitting section 240. Moving speed measuring section 230 decides that, for example, the moving speed of the terminal is low, middle or high. The decision criterion for the moving speed of the terminal may be the Doppler frequency, for example. For example, it may be interpreted that, when the Doppler frequency is higher, the moving speed is higher and, when the Doppler frequency is lower, the moving speed is lower. Further, it can be interpreted that the decision criterion for the moving speed may employ the number of times of handover in case where a terminal is in communication and the number of times of cell selection in case where the terminal is in an idle state. For example, it can be interpreted that, when the number of times of handover or the number of times of cell selection per unit time is greater, the moving speed is higher, and, when the number of times of handover or the number of times of cell selection per unit time is smaller, the moving speed is lower.

Response signal transmitting section 240 transmits a response signal to the network based on the command from gap duration timer 160 and the moving speed of the terminal outputted from moving speed measuring section 230. Here, response signal transmitting section 240 decreases the number of times of response signals are transmitted when the terminal is moving at high speed, and increases the number of times of response signals are transmitted when the terminal is moving at low speed.

The base station controls “G_Offset” based on the number of times of response signals transmitted from the terminal are received, and, for example, when the number of times of response signals are received in “G_Offset” goes below the threshold, the base station decreases “G_Offset” with respect to the terminal moving at high speed. Consequently, a longer gap length is set to the terminal moving at high speed, so that it is possible to reduce the measurement time according to the moving speed of the terminal.

Here, a specific example will be given and explained. For example, in case where the terminal moves at high speed of 350 kilometers per hour, in the cell with the radius of one kilometer (i.e. the diameter of 2 kilometers), the terminal takes about ten seconds at maximum to pass the cell. At this time, assuming that the interval between gaps is 120 milliseconds and the time required for measurement is 480 milliseconds, if a long

“G_Offset,” the gap length of which is 6 milliseconds after application of “G_Offset,” is applied, 80 gaps are required to perform measurement using gaps. In this ease, the time required for measurement using gaps is about ten seconds, and therefore there is a high possibility that the terminal moving at high speed moves to the next cell by the time measurement is finished.

On the other hand, if short “G_Offset,” the gap length of which is 12 milliseconds after application of “G_Offset,” is applied, 40 gaps are required for measurement. In this case, the time required for measurement using gaps is about 5 seconds, and therefore it is possible to finish measurement before the terminal moving at high speed moves to the next cell.

In this way, by applying short “G_Offset” to the terminal moving at high speed, it is possible to finish measurement before the terminal moves to another cell.

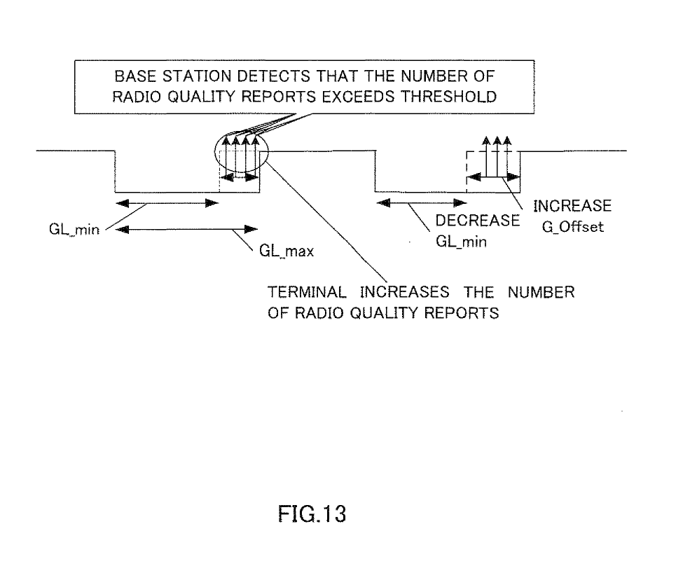

FIG. 13 shows that the gap length is changed in case where the terminal is moving at low speed. By increasing the number of radio quality reports in “G_Offset” in the terminal, the base station detects that the number of radio quality reports exceeds the threshold, and applies long “G_Offset.”

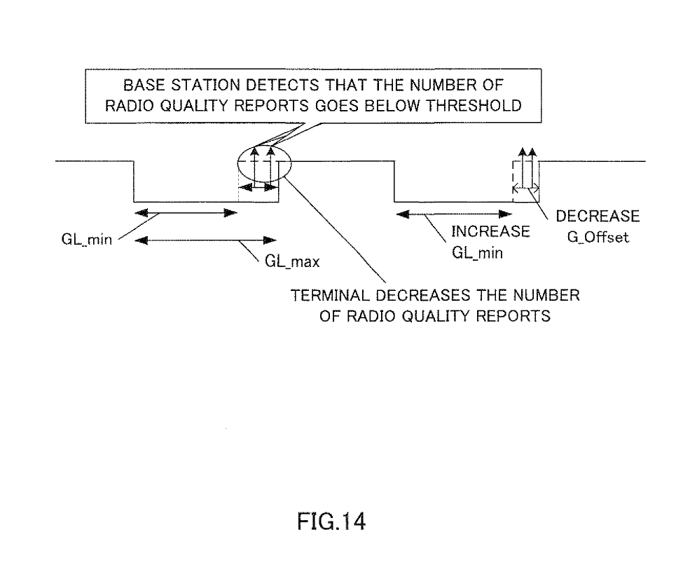

FIG. 14 shows that the gap length is changed in case where the terminal is moving at high speed. By decreasing the number of radio quality reports in “G_Offset” in the terminal, the base station detects that the number of radio quality reports goes below the threshold, and applies short “G_Offset.”

Further, with the present embodiment, by limiting measurement target cells with respect to the terminal moving at high speed, it is possible to further reduce the measurement time. There are two types of methods for limiting the number of measurement target cells. The first method is directed to, in measurement section 150, limiting the number of cells to measure by setting priority of measurement with respect to a plurality of frequency candidates to measure and determining “how many frequency candidates from the highest priority are measured.”

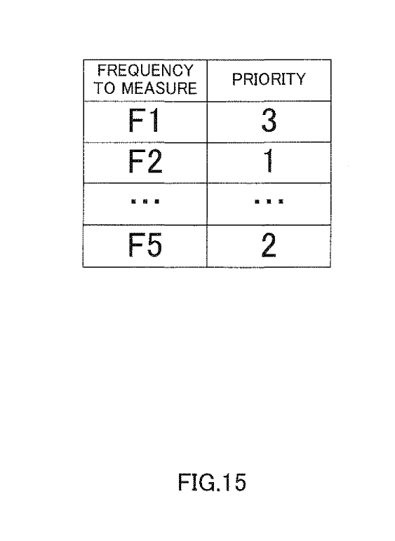

FIG. 15 is a table showing a list of measurement target frequencies and priorities matching the frequencies to measure. For example, in the list of FIG. 15, the terminal moving at low speed measures all frequencies of F1 to F5, and the terminal moving at high speed measures only frequencies F2 and F5 of priorities 1 and 2. Further, generally speaking, when the terminal is in communication, the terminal does not have priority information and therefore acquires priority information by keeping priority information held when the terminal is in an idle state, even after the terminal is set in communication, or by receiving priority information broadcasted from the network.

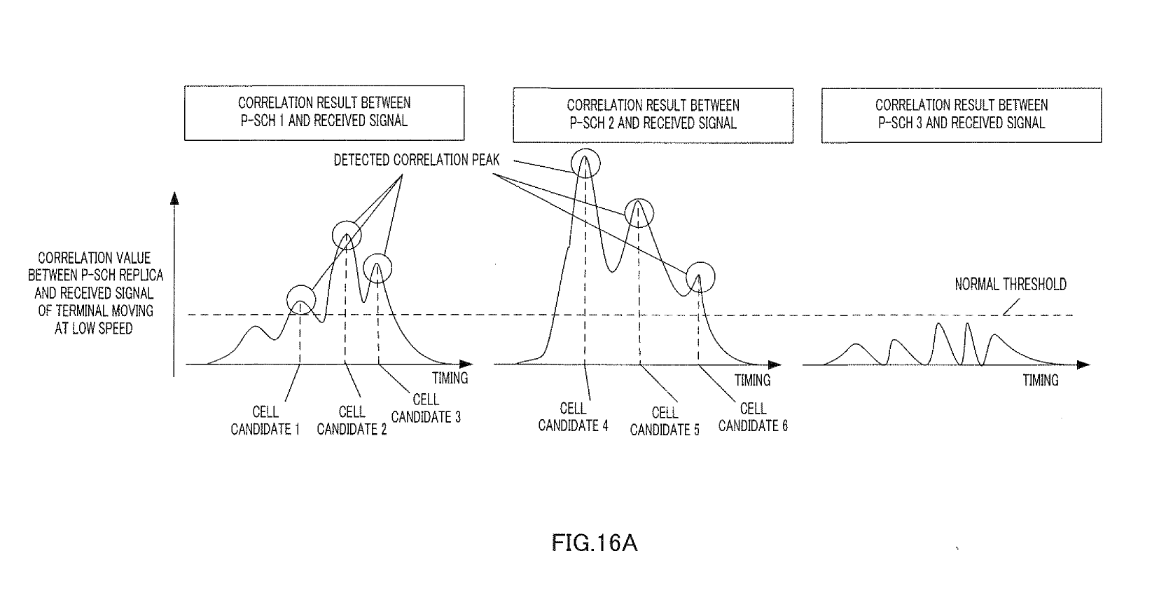

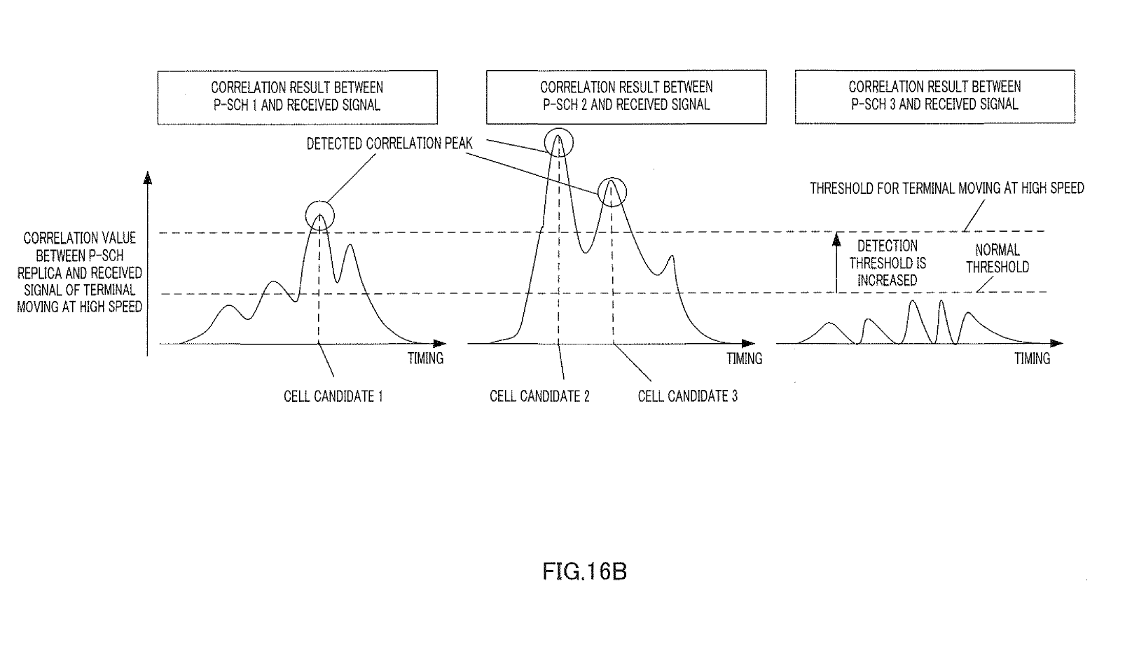

The other method of limiting the number of measurement target cells is directed to, in measurement section 150, limiting the number of cells to measure in a cell search before the received quality of a reference signal is measured. First, in initial timing synchronization processing in the cell search processing step, a terminal performs cross-correlation calculation between a received signal and a replica of primary SCH (“P-SCH”) of a synchronization channel which is a known pattern. The terminal decides that the timing of a high correlation peak value in this cross-correlation calculation result is the transmission timing of P-SCH from the base station that provides good received quality to the terminal. Accordingly, by determining a setting “how many timings from the highest correlation peak are selected” from timings showing correlation peaks, it is possible to limit the number of cells to measure. Instead, by increasing the detection threshold of correlation values for selecting timings, it is possible to limit the number of timings of cells to select, and limit the number of cells. For example, if there are known three patterns of P-SCR's (P-SCH1, P-SCH2 and P-SCH3), correlations between a received signal and P-SCR's of three patterns are calculated and correlation values are compared. FIG. 16A shows a correlation value between P-SCH and a received signal of a terminal moving at low speed, and FIG. 16B shows a correlation value between P-SCH and a received signal of a terminal moving at high speed. Further, each graph of FIG. 16A and FIG. 16B shows each correlation result between a received signal and each of P-SCH1, P-SCH2 and P-SCH3 from the left. As shown in FIG. 16A and FIG. 16B, generally, by increasing the threshold that is used to select a timing in case of the terminal moving at high speed, it is possible to limit the number of timings of cells to select, from 6 to 3.

### Embodiment 7

A case will be explained with Embodiment 7 of the present invention where an event occurs. Here, the occurrence of an event will be briefly explained. First, the terminal performs measurement to connect to a cell that provides good received quality at all times, and measures the received quality of signals from neighboring cells. When, for example, the received quality from the cell with which the terminal is currently communicating goes below the threshold and, based on this measurement result, the terminal detects a cell of better received quality than the cell with which the terminal is currently communicating, the terminal decides that an event has occurred. This event occurs when the received quality of a neighboring cell to which the terminal needs to be handed over or the received quality to which the terminal is currently connected satisfies a specific condition. After an event occurs, the terminal reports a measurement result to the base station. Further, the terminal reports a measurement result on a regular basis after an event occurs. Further, a neighboring cell of good received quality is not yet detected before an event occurs, and therefore it is necessary to detect a cell of good received quality as soon as possible.

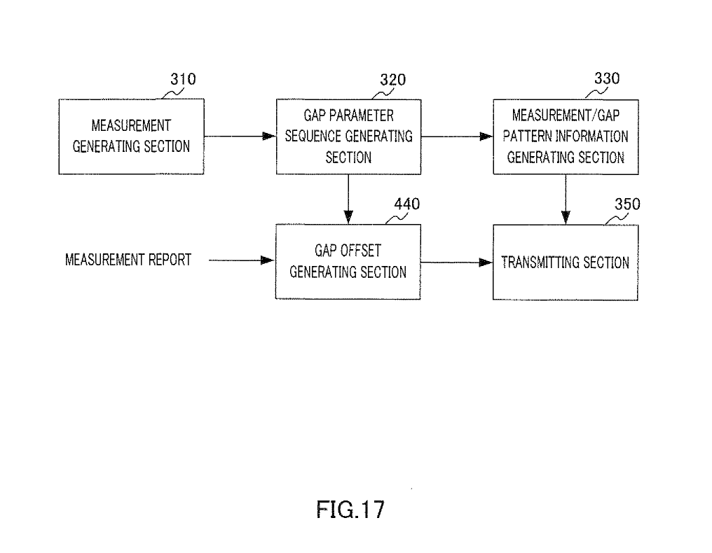

The configuration of the terminal according to Embodiment 7 of the present invention is the same as in FIG. 1 of Embodiment 1 and therefore FIG. 1 will be appropriated here. The configuration of the base station according to Embodiment 7 of the present invention will be explained using FIG. 17. Note that FIG. 17 differs from FIG. 2 in changing gap offset generating section 340 to gap offset generating section 440. If an event occurs as a result of performing measurement in the terminal, the terminal transmits a measurement report and gap offset generating section 440 of the base station receives the measurement report as input.

When receiving as input a measurement report, gap offset generating section 440 can decide that an event has occurred in the terminal and, consequently, changes “G_Offset” to long “G_Offset” and recalculates the minimum gap length based on the changed gap offset. Further, when the base station does not yet receive the measurement report as input, gap offset generating section 440 can decide that an event has not occurred yet in the terminal, and, consequently, changes “G_Offset” to short “G_Offset” and recalculates the minimum gap length based on the changed gap offset. The changed gap offset parameter is outputted to transmitting section 350. Further, note that a measurement report is transmitted from the terminal on a regular basis even after an event has occurred.

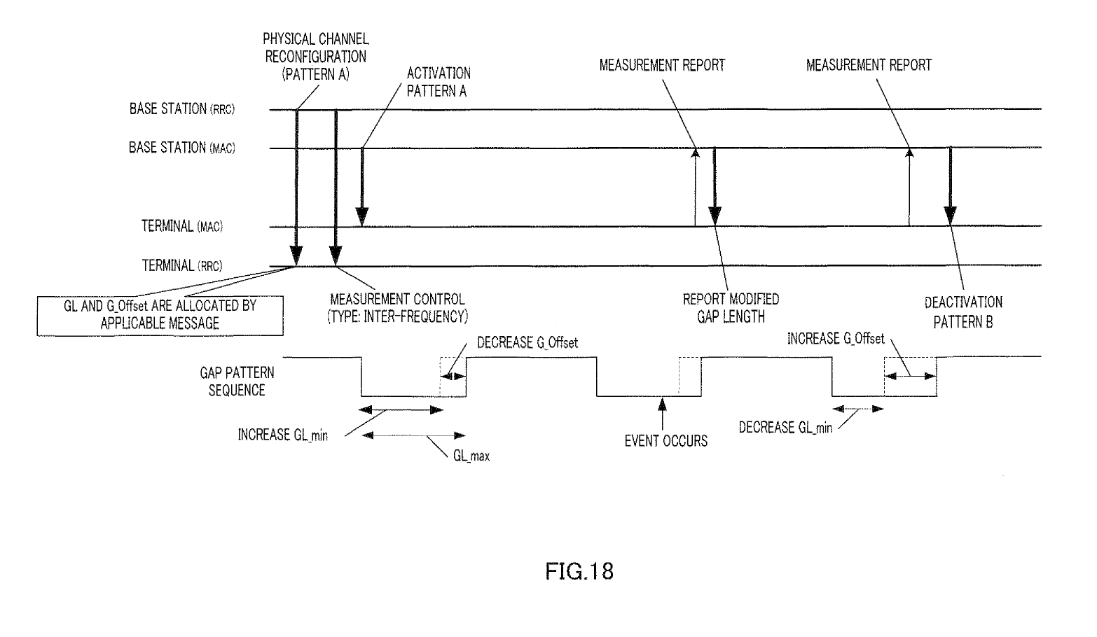

FIG. 18 shows a signaling flowchart between the terminal shown in FIG. 1 and the base station shown in FIG. 17. FIG. 18 differs from FIG. 3, and, while FIG. 3 shows that the change of the gap length is reported to the base station by changing the number of radio quality reports, FIG. 18 shows that the change of the gap length is reported to the base station depending on whether or not there is a measurement report.

If the gap length alone is reduced after an event has occurred, delay occurs when measurement of any frequency or cell is performed. Generally, after an event has occurred, a measurement report is transmitted on a regular basis. This is because it is necessary to report to the base station the latest received quality information of the cell in which an event has occurred. Accordingly, if delay occurs by reducing the gap length alone, it is not possible to report the latest received quality information to the base station.

Therefore, with the present embodiment, the measurement time is reduced not only by simply reducing the gap length after an event has occurred but also by limiting the number of measurement target cells in comparison with before an event occurs. By this means, it is possible to alleviate the influence of measurement delay and improve throughput. Further, the two methods explained in Embodiment 6 as the method of limiting the number of measurement target cells are available.

In this way, according to the present embodiment, by applying short “G_Offset” before an event occurs (or by applying no “G_Offset”) and applying long “G_Offset” after an event has occurred, it is possible to detect a neighboring cell of good received quality earlier before an event occurs and improve throughput after an event has occurred.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may he individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

Further, there are cases where the base station and the mobile station in the above embodiments may be referred to as “Node B” and “UE,” respectively.

The disclosures of Japanese Patent Application No. 2007-161956, filed on Jun. 19, 2007, and Japanese Patent Application No. 2008-074330, filed on Mar. 21, 2008, including the specifications, drawings and abstracts, are incorporated herein by reference in their entirety.

### INDUSTRIAL APPLICABILITY

The wireless communication base station apparatus, wireless communication terminal apparatus and gap generating method according to the present invention can reduce signaling load and perform flexible gap allocation, and is applicable to, for example, a mobile communication system such as LTE.

1. A wireless communication terminal apparatus comprising:
a receiving section that receives gap parameter configuration information;
a target gap length generating section that generates a target gap length by subtracting a gap offset from a maximum allowable gap length using the gap parameter configuration information, and that generates a target gap length again when a new gap offset is acquired; and
a measurement section that performs measurement based on the generated target gap length.

2. The wireless communication terminal apparatus according to claim 1, wherein the target gap length generating section modifies the gap offset based on a threshold decision result of a predetermined threshold and a number of response signals which are transmitted from a wireless communication base station apparatus to report radio quality, and generates the target gap length using a modified gap offset.

3. The wireless communication terminal apparatus according to claim 1, wherein the target gap length generating section determines the gap offset based on traffic load information showing an amount of traffic in a serving cell, and generates the target gap length based on the determined gap offset.

4. The wireless communication terminal apparatus according to claim 1, further comprising:
a moving speed measuring section that measures a moving speed of the wireless communication terminal apparatus; and
a response signal transmitting section that transmits the response signal by increasing a number of times response signals are transmitted when the measured moving speed is higher, and decreasing the number of times the response signals are transmitted when the moving speed is lower.

5. A wireless communication base station apparatus comprising:
a minimum gap length calculating section that calculates a minimum gap length using a gap offset and a maximum allowable gap length allocated based on a measurement requirement of a wireless communication terminal apparatus;
a gap offset generating section that generates the gap offset based on a threshold decision result of a predetermined threshold and a number of response signals transmitted from the wireless communication terminal apparatus; and
a transmitting section that transmits the minimum gap length and the gap offset.

6. The wireless communication base station apparatus according to claim 5, further comprising a minimum/maximum allowable gap length determining section that allocates varying measurement setting information to a minimum gap length and a maximum allowable gap length.

7. The wireless communication base station apparatus according to claim 5, further comprising a resource scheduling section that schedules radio resources allocated to the wireless communication terminal apparatus and overlapping gaps allocated to the wireless communication terminal apparatus, to another wireless communication terminal apparatus.

8. The wireless communication base station apparatus according to claim 5, wherein the gap offset generating section generates a long gap offset when a measurement report is acquired from the wireless communication terminal apparatus, and generates a short gap offset when the measurement report is not acquired.

9. A gap generating method comprising:
receiving gap parameter configuration information;
generating a target gap length by subtracting a gap offset from a maximum allowable gap length using the gap parameter configuration information;
generating a target gap length again when a new gap offset is acquired; and
generating a gap pattern based on the target gap length that is generated or generated again.
